(19) United States
(12) Patent Application Publication
(10) Pub. No.: US 2020/0122552 A1
(43) Pub. Date: Apr. 23, 2020

(54) AIR INTAKE FOR VEHICLE HVAC SYSTEM

(71) Applicants: DENSO International America, Inc., Southfield, MI (US); Denso Corporation, Kariya (JP)

(72) Inventor: Mark Allen ROTHENBERG, Farmington Hills, MI (US)

(21) Appl. No.: 16/164,441

(22) Filed: Oct. 18, 2018

(51) Int. Cl. B60H 1/30

(52) U.S. Cl. CPC B60H 1/30

(57) ABSTRACT

A vehicle climate control system includes an air scoop, a vertical duct, and an airfoil. The air scoop is disposed along a bottom surface of a vehicle floor panel. The vertical air duct extends upward from the air scoop and is configured direct air from the scoop toward a heat exchanger. The airfoil is disposed within the air scoop and is arranged to direct air entering the air scoop upwards and into the vertical air duct.

### TECHNICAL FIELD

The present disclosure relates to heating, ventilation, and air conditioning (HVAC) system for vehicles.

### BACKGROUND

Vehicles may include HVAC systems that are configured to deliver air to the vehicle cabin. The HVAC systems of the vehicle may also be configured to control the temperature of the air within the vehicle cabin.

### SUMMARY

A vehicle climate control system includes an air scoop, a vertical duct, and an airfoil. The air scoop is disposed along a bottom surface of a vehicle floor panel. The vertical air duct extends upward from the air scoop and is configured to direct air from the scoop toward a heat exchanger. The airfoil is disposed within the air scoop and is arranged to direct air entering the air scoop upwards and into the vertical air duct.

A vehicle includes a heat exchanger, an air scoop, an air duct, and an airfoil. The heat exchanger is configured to condition air being delivered to a cabin of the vehicle. The air scoop is disposed along an exterior bottom surface of the vehicle. The air duct extends upward from the air scoop and is configured to establish fluid communication between the air scoop and the heat exchanger. The airfoil is disposed within the air scoop and is arranged to direct air entering the air scoop upwards and into the vertical air duct.

An air intake for a vehicle ventilation system includes an air scoop, a vertically extending duct, and an airfoil. The air scoop is in fluid communication with the surrounding ambient air and the vertically extending duct. The airfoil is disposed within the air scoop and is arranged to direct air entering the air scoop upwards and into the duct.

### BRIEF DESCRIPTION OF THE DRAWINGS

FIG. 1 is a schematic illustration of an exemplary vehicle and an exemplary HVAC system of a vehicle;

FIG. 2 is a bottom view of the vehicle;

FIG. 3 is a cross-sectional view of an air intake for the HVAC system of the vehicle taken along line 3-3 in FIG. 2;

FIG. 4 is a perspective top view of an airfoil; and

FIG. 5 is a perspective bottom view of the airfoil.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

It is common practice to house the HVAC intake plenum in a vehicle crossmember at the base of the front windshield. The HVAC system is typically mounted to the vehicle dashboard (or sometimes to the firewall). Fresh air enters in through a hole in the firewall using a cross-car frame member such as a grill and fresh air plenum. This cross-car frame member is typically trough-shaped to allow water to flow away from the HVAC inlet. The water is usually drained out towards the fenders of the vehicle.

As future motive technologies develop (particularly electric cars), an engine may no longer be placed within an engine compartment of the vehicle that is in front of the vehicle occupants. This creates new opportunities to develop packaging systems for HVAC system components that are positioned within vehicles at locations other than the dashboard, including components that are specific to the intake and delivering of fresh-air into the HVAC systems of vehicles.

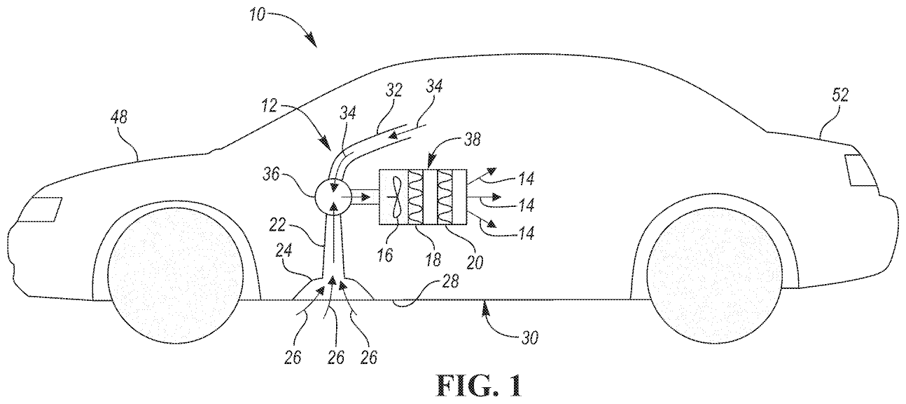

Referring to FIG. 1, an exemplary vehicle 10 and an exemplary HVAC system 12 of the vehicle 10 are illustrated. Some components of the HVAC system 12 may be disposed behind a dashboard of the vehicle 10. The dashboard is not shown in FIG. 1 for illustrated purposes. However, some the components may be disposed at other locations within the vehicle. The HVAC system 12 is configured to deliver air to a cabin of the vehicle 10. The air being delivered to the cabin vehicle is illustrated by arrows 14. The HVAC system 12 may be configured to condition the air (e.g., heat, cool, dry, etc.) prior to delivering the air to the vehicle cabin.

A blower or fan 16 is configured to draw air into the HVAC system 12 and to direct the air across one or more heat exchangers in order to condition the air being delivered to the vehicle cabin prior to delivering the air to the vehicle cabin. The fan 16 may be any type of fan. For example, the fan 16 may be a centrifugal fan. The fan 16 may include an electric motor (not shown) that is configured to turn the blades of the fan 16. The electric motor of the fan 16 may draw power from any electrical power source of the vehicle 10. For example, the electric motor of the fan 16 may draw power from a battery or an onboard generator (e.g., an alternator).

A first of the heat exchangers may be an evaporator 18 that is configured to cool and dry the air prior to delivering the air to the vehicle cabin. The evaporator 18 cools and dries the air by transferring heat from the air to a refrigerant that is flowing through the evaporator 18 as the air flows across the evaporator. The evaporator 18 may be a subcomponent of an air-conditioning system. More specifically, the evaporator 18 may be a subcomponent of a refrigerant loop that also includes a compressor, a condenser, and thermal expansion valve.

A second of the heat exchangers may be a heater core 20 that is configured to warm the air prior to delivering the air to the vehicle cabin. The heater core 20 warms the air by transferring heat from a coolant flowing through the heater core 20 into the air as the air flows across the heater core 20. The heater core 20 may be a subcomponent of a coolant loop that also includes a pump to circulate the fluid through the coolant loop and a heat source that is configured to heat the coolant within the coolant loop. If the vehicle 10 is powered by an internal combustion engine, the heat source of the coolant loop may be the engine. If the vehicle 10 is not powered by an internal combustion engine (e.g., an electric vehicle that is powered by an electric motor) the heat source of the coolant loop may be an electric heater that is powered by a battery or any other electrical power source of the vehicle 10 (e.g., an alternator). In the case of an electric vehicle, the heater may alternatively be a direct electric heater (i.e., an electric heater that directly heats the air being delivered into the vehicle cabin, as opposed to a heater that heats a coolant within a coolant loop). A direct electric heater may be either an electric coil or a positive temperature coefficient (PTC) heater. Other alternative applications may use battery heat, electric motor heat, or heat pumps (a heat exchanger that both heats and/or cools the cabin) to heat or cool the air being delivered to the vehicle cabin.

The HVAC system 12 may include a series of interconnected ducts that are configured to channel the air to the evaporator 18, heater core 20, and eventually to the cabin of the vehicle 10. A first duct 22 is configured to channel ambient air surrounding the vehicle 10 from an air intake 24 into the HVAC system 12. More specifically, the first duct 22 is configured to channel the ambient surrounding air to the evaporator 18, heater core 20, and eventually to the cabin of the vehicle 10. The ambient air entering the HVAC system 12 is illustrated by arrows 26. The first duct 22 may be referred to as a fresh air duct and the air intake 24 may be referred to as a fresh air intake. The air intake 24 may more specifically be disposed along a bottom surface 28 the vehicle 10. The bottom surface 28 of the vehicle 10 may more specifically be a bottom surface of a floor or a floor panel 30 of the vehicle 10.

A second duct 32 is configured to channel air from within the cabin of the vehicle 10 back into the HVAC system 12. More specifically, the second duct 32 is configured to channel air from within the cabin of the vehicle 10 to the evaporator 18, heater core 20, and eventually back into to the cabin of the vehicle 10. The air being channeled from the cabin of the vehicle 10 back into the HVAC system 12 may be referred to as recirculated air. The recirculated air is illustrated by arrows 34. The second duct 32 may be referred to as a recirc air duct.

The recirculated air and the ambient air entering the HVAC system 12 may each be directed to a common duct or mixing chamber 36 where the recirculated air and the ambient air are mixed. The mixed air is then delivered to an additional duct or conditioning chamber 38 where the air is cooled and/or heated via the evaporator 18 and/or the heater core 20, respectively. The air then exits the conditioning chamber 38 and enters the vehicle cabin through various outlets (not shown) as illustrated by arrows 14.

It should be understood that the schematic illustrated in FIG. 1 is merely exemplary and is not intended to be limiting. Other HVAC configurations are contemplated that utilize ducts to channel ambient air and/or recirculated air into the HVAC system where the air is conditioned and then delivered to the cabin of the vehicle. For example, the HVAC system may include multiple outlets from the HVAC system that direct air into the cabin at different directions (e.g., floor outlets, dashboard outlet, defrost outlets), multiple ambient air intakes, multiple recirc air ducts, doors or shutters disposed within the ducts that restrict air flow to specific ducts, intakes, outlets, etc. The outlets may include louvers or shutters that restrict or direct the air entering into the cabin. The number of heat exchangers may be different (e.g., the HVAC system may not include an evaporator if the vehicle does not include a cabin air cooling system), the spatial positioning of the heat exchangers (e.g., evaporator 18 and heater core 20) and fan 16 may be rearranged, or alternative devices (e.g., PTC heaters, heat pumps, etc.) may be utilized to condition the cabin air.

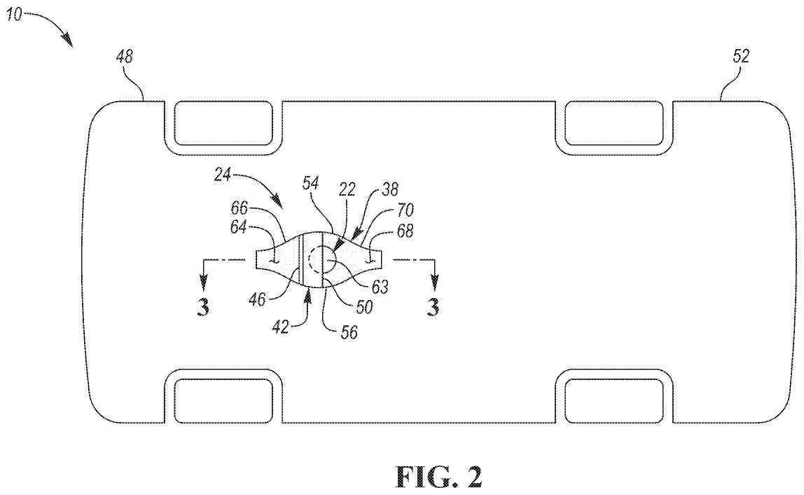

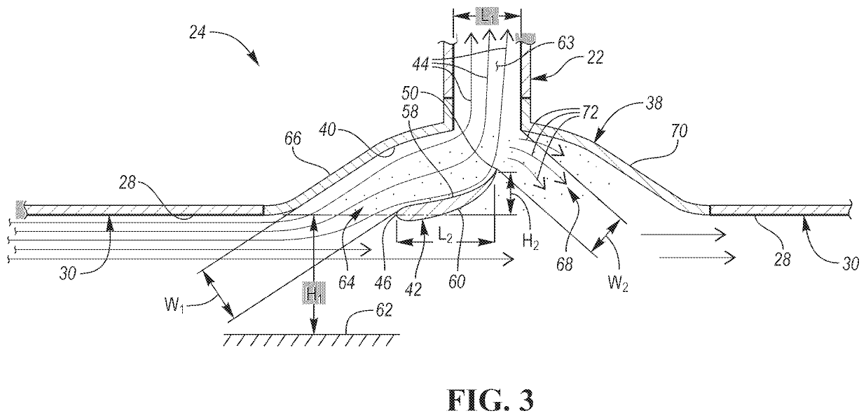

Referring to FIGS. 2 and 3, a bottom view of the vehicle 10 and a cross-sectional view of the air intake 24 for the HVAC system 12 are illustrated, respectively. The air intake includes an air scoop 38. The air scoop 38 may be part of floor panel 38 or a separate component that is connected to the floor panel 38 as shown. The air scoop 38 is disposed along the bottom surface 28 the vehicle 10. More specifically, the air scoop 38 is disposed along the bottom surface 28 of the floor or floor panel 30 of the vehicle 10.

The air scoop 38 includes an internal surface 40 that is recessed upward into the vehicle 10 relative to the floor panel 30. The internal surface 40 may be concave or “bowl” shaped. The air scoop 38 may be a National Advisory Committee for Aeronautics (NACA) duct, which may also be referred to as a NACA scoop or a NACA inlet. The air scoop 38 is in fluid communication with the surrounding ambient air and a vertically extending duct (i.e., the first duct 22). The first duct 22 extends vertically upward from the air scoop 38 and is configured direct air from the air scoop 38 toward one or more heat exchangers (i.e., the evaporator 18 or heater core 20). The first duct 22 establishes fluid communication between the one or more heat exchangers and the air scoop 38.

An airfoil 42 is disposed within the air scoop 38 and is positioned and arranged to direct air entering the air scoop 38 upward and into the first duct 22. More specifically, the air scoop 38 is configured direct the air that is flowing adjacent to the bottom surface 28 of the floor panel 30 upward and into the first duct 22 while the vehicle 10 is moving forward. The air that flows adjacent to the bottom surface 28 of the floor panel 30 and is subsequently directed upward and into the first duct 22 is illustrated by arrows 44.

A leading edge 46 of the airfoil 42 is oriented towards (i.e., points or faces toward) a front end 48 of the vehicle 10. A trailing edge 50 of the airfoil 42 is oriented towards (i.e., points or faces toward) a rear end 52 of the vehicle 10. The airfoil 42 may extend laterally and span between a first side 54 of the air scoop 38 and a second side 56 of the air scoop 38. More specifically, a cross-sectional area of the airfoil 42 that is bound by the leading edge 46, an upper surface 58 of airfoil 42, the trailing edge 50, and a lower surface 60 of the airfoil 42 may extend laterally and span between the first side 54 of the air scoop 38 and the second side 56 of the air scoop 38 The first side 54 and the second side 56 of the air scoop 38 may be referred to as opposing sides of the air scoop 38.

The leading edge 46 of the airfoil 42 has a height H₁ from a respective road or ground surface 62 that is approximately equal to the height of the bottom surface 28 of the floor panel 30 from the road or ground surface 62. The height H₁ dimension may be measured in the same direction as the of the force of gravity. The airfoil 42 is placed longitudinally between the front end 48 of the vehicle 10 and the rear end 52 of the vehicle 10 such that the trailing edge 50 is located below the central opening 63 in the first duct 22 relative to the direction of the force of gravity. In a preferred embodiment, the trailing edge 50 may be positioned longitudinally within a desired tolerable range from being positioned exactly below a middle point of the central opening 63 in the first duct 22 (i.e., within a length that measures up to 25% of the longitudinal length L₁ across the central opening 63 the first duct 22 from the middle point of the central opening 63 in the first duct 22). However, the trailing edge 50 may be positioned below the central opening in the first duct 22 at any position below the central opening in the first duct 22 that is within the longitudinal length L₁ of the central opening in the first duct 22 that extends in the direction between the front end 48 of the vehicle 10 and the rear end 52 of the vehicle 10.

The airfoil 42 may be rotated or oriented such that the trailing edge 50 is higher in position relative to the leading edge 46 relative to the direction of gravity. The airfoil 42 may have a longitudinal length L₂ that extends from the leading edge 46 to the trailing edge 50 in the longitudinal direction between the front end 48 of the vehicle 10 and the rear end 52. The airfoil 42 may also have a height H₂ that extends from the leading edge 46 to the trailing edge 50. The height H₂ dimension of the airfoil may also be measured relative to the direction of the force of gravity. A ratio of the longitudinal length L₂ to the height H₂ of the airfoil may have any value that ranges between 6:1 and 1:1.

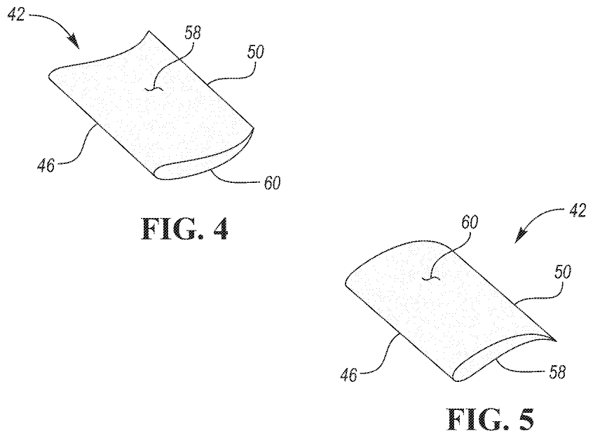

Referring to FIGS. 3, 4, and 5, the airfoil 42 is further illustrated. The airfoil 42 may be any type of airfoil, including symmetrical and non-symmetrical (cambered) type airfoils. In a preferred embodiment the airfoil 42 is a cambered type airfoil. The airfoil 42, if cambered, may have a first surface that is convex and a second surface that is either convex, concave, or flat. In a preferred embodiment, the airfoil 42 is cambered where the upper surface 58 is concave and the lower surface 60 is convex.

Referring again to FIGS. 2 and 3, the air scoop 38 and the airfoil 42 (or more specifically the leading edge 46 of the airfoil 42) define an air inlet 64 along a front side 66 of the air scoop 38. The air scoop 38 and the airfoil 42 (or more specifically the trailing edge 50 of the airfoil 42) define a debris outlet 68 along a rear side 70 of the air scoop 38. The positioning of the airfoil 42 is configured to direct air coming in through the inlet 64 upwards and into the first duct 22. Heavier materials such as debris, rocks, dirt, water, etc., however, are unable to flow upwards against the force of gravity and into the remainder of the HVAC system 12, where such heavier materials may cause damage. Any of the heavier materials or debris that flows into the air scoop 38 at the inlet 64 is pushed by the air flowing within the air scoop 38 back and toward the debris outlet 68, where the heavier materials or debris are then expelled out of the air scoop 38 and to the ambient surroundings. The heavier materials that are being expelled out of the air scoop 38 are illustrated by arrows 72.

The air inlet 64 may have a width W₁ that extends from to the leading edge 46 of the airfoil 42 to a point on the internal surface 40 of the air scoop 38 that is closest to the leading edge 46 of the airfoil 42. The debris outlet 68 may have a width W₂ that extends from trailing edge 50 of the airfoil 42 to a point on the internal surface 40 of the air scoop 38 that is closest to the trailing edge 50 of the airfoil 42. The width W₂ of the debris outlet 68 may be sized to be greater than the width W₁ of air inlet 64 to prevent debris from becoming entrapped within the air scoop 38 (i.e., any debris that is able to enter into the air scoop 38 at the air inlet 64 will also be able to exit air scoop 38 at the debris outlet 68 since the debris outlet 38 is larger than the air inlet 64).

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, to the extent any embodiments are described as less desirable than other embodiments or prior art implementations with respect to one or more characteristics, these embodiments are not outside the scope of the disclosure and can be desirable for particular applications.

What is claimed is:

1. A vehicle climate control system comprising:
an air scoop disposed along a bottom surface of a vehicle floor panel;
a vertical air duct extending upward from the air scoop and configured direct air from the scoop toward a heat exchanger; and
an airfoil disposed within the air scoop and arranged to direct air entering the air scoop upwards and into the vertical air duct.

2. The climate control system of claim 1, wherein the airfoil extends laterally between opposing sides of the air scoop.

3. The climate control system of claim 1, wherein the air scoop and the air foil define an air inlet along a front side of air scoop.

4. The climate control system of claim 3, wherein the air scoop and the air foil define a debris outlet along a rear side of air scoop.

5. The climate control system of claim 1, wherein the airfoil is a cambered airfoil.

6. The climate control system of claim 5, wherein an upper surface of the airfoil is concave.

7. The climate control system of claim 5, wherein a lower surface of the airfoil is convex.

8. A vehicle comprising:
a heat exchanger configured to condition air being delivered to a cabin;
an air scoop disposed along an exterior bottom surface of the vehicle;
an air duct extending upward from the air scoop and configured to establish fluid communication between the air scoop and the heat exchanger; and
an airfoil disposed within the air scoop and arranged to direct air entering the air scoop upwards and into the air duct.

9. The vehicle of claim 8, wherein the airfoil extends laterally between opposing sides of the air scoop.

10. The vehicle of claim 8, wherein the air scoop and the air foil define an air inlet along a front side of air scoop.

11. The vehicle of claim 10, wherein the air scoop and the air foil define a debris outlet along a rear side of air scoop.

12. The vehicle of claim 8, wherein the airfoil is a cambered airfoil.

13. The vehicle of claim 12, wherein an upper surface of the airfoil is concave.

14. The vehicle of claim 12, wherein a lower surface of the airfoil is convex.

15. An air intake for a vehicle ventilation system comprising:
an air scoop in fluid communication with surrounding ambient air and a vertically extending duct; and
an airfoil disposed within the air scoop and arranged to direct air entering the air scoop upwards and into the duct.

16. The air intake of claim 15, wherein the air scoop and the air foil define an air inlet along a front side of air scoop.

17. The air intake of claim 16, wherein the air scoop and the air foil define a debris outlet along a rear side of air scoop.

18. The vehicle of claim 15, wherein the airfoil is a cambered airfoil.

19. The vehicle of claim 18, wherein an upper surface of the airfoil is concave.

20. The vehicle of claim 18, wherein a lower surface of the airfoil is convex.
